(19) United States
(12) Patent Application Publication
(10) Pub. No.: US 2012/0201633 A1
(43) Pub. Date: Aug. 9, 2012

(54) WORKPIECE TRANSFER SYSTEM AND FRAME STRUCTURE FOR TRANSFER CHAMBER

(75) Inventors: Yasunobu OTOGAWA, Osaka (JP); Yoshiyuki MATSUZAKI, Osaka (JP); Haruo MAETANI, Osaka (JP); Kota HOSHIJIMA, Osaka (JP)

(73) Assignee: DAIHEN CORPORATION, Osaka (JP)

(21) Appl. No.: 13/352,847

(22) Filed: Jan. 18, 2012

(30) Foreign Application Priority Data
Feb. 4, 2011 (JP) 2011-022405

(51) Int. Cl. B65G 47/90

(52) U.S. Cl. 414/226.05

(57) ABSTRACT

A workpiece transfer system includes a transfer chamber in which a workpiece transfer apparatus is installed, and a load port provided adjacent to the transfer chamber. The transfer chamber includes a frame structure made of steel. The frame structure includes a first frame member and a second frame member. The first frame member is set on the floor, and the workpiece transfer apparatus is installed thereon. The second frame member is arranged in a standing posture with respect to the first frame member and which supports the load port.

### BACKGROUND OF THE INVENTION

1. Field of the Invention

The present invention relates to a workpiece transfer system for transferring workpieces in the form of a thin plate in e.g. manufacturing semiconductor devices. More specifically, the invention relates to a workpiece transfer system including a transfer chamber in which a workpiece transfer apparatus is to be installed and a load port provided adjacent to the transfer chamber.

2. Description of the Related Art

In the manufacture of semiconductor devices, a robot for transferring workpieces such as wafers (hereinafter referred to as a “workpiece transfer apparatus”) is used. A workpiece transfer system including such a workpiece transfer apparatus is known (see JP-A-2003-188231, for example).

FIG. 6 shows an example of conventional workpiece transfer system. The workpiece transfer system 9 illustrated in the figure includes a transfer chamber 91, two load ports 92, a workpiece treatment chamber 93 and a workpiece transfer apparatus 94. The transfer chamber 91 is generally in the form of a rectangular parallelepiped having an internal space, in which the workpiece transfer apparatus 94 is installed. The load ports 92 are arranged adjacent to one side of the transfer chamber 91 and supported on a side wall 91a of the transfer chamber 91. A cassette (container) 921 for holding a plurality of workpieces W is set to each of the load ports 92. The workpiece treatment chamber 93 is arranged adjacent to the side of the transfer chamber 91 opposite from the load ports 92. In the workpiece treatment chamber 93, treatment such as working, testing is performed with respect to the workpieces W. The workpiece transfer apparatus 94 comprises a horizontal articulated robot including e.g. two arms 942, 943 and a hand 944 for holding a workpiece which are connected to each other rotatably within a horizontal plane. The workpiece transfer apparatus 94 transfers the workpieces W relative to each of the load ports 92 and the workpiece treatment chamber 93 by appropriately controlling the operation of the two arms 942, 943 and the hand 944.

For easy installation and flexibility in design, the transfer chamber 91 of the workpiece transfer system 9 has a frame structure made by using e.g. drawn aluminum (aluminum profile), which is inexpensive and small in weight. The workpiece transfer apparatus 94 is placed and fixed on the bottom of the transfer chamber 91.

The size of the workpieces W, which are an object to be transferred by the workpiece transfer apparatus 94, tends to increase. For instance, in the field of semiconductor device manufacture, wafers having a diameter larger than 300 mm are expected to be used instead of the wafers having a diameter of 300 mm. Such an increase in size of the workpieces W leads to an increase in the transfer distance of the workpieces W in vertical and horizontal directions.

For avoiding a decrease in productivity, it is desirable that longer time is not taken for transferring a larger workpiece X. Accordingly, to transfer a relatively large workpiece X, the arms 942, 943 and the hand 944 need to be rotated at a relatively high speed to increase the workpiece transfer speed. In that case, the acceleration or deceleration also increases.

During the workpiece transferring operation by the workpiece transfer apparatus 94, vibration is generated due to the inertial force caused by change in speed of each member (arms 942, 943 and hand 944). When the transfer speed and the acceleration or deceleration in the workpiece transferring operation increases in accordance with an increase in size of the workpieces, vibration occurring in the workpiece transfer apparatus 94 also increases. In particular, the transfer chamber 91 made of a light material such as aluminum profile easily bends or flexes, so that the transfer chamber 91 vibrates when vibration occurs at the workpiece transfer apparatus 94. When the transfer chamber 91 vibrates, the load ports 92 supported by the transfer chamber 91 and the workpiece transfer apparatus 94 also vibrate. Vibration occurs in a different manner in the transfer chamber 91, the load ports 92 and the work piece transfer apparatus 94, and this may lead to an increase in vibration of the entire workpiece transfer system 9 or a delay in damping the vibration.

The cassette 921 set to each load port 92 accommodates a plurality of workpieces W stacked one on top of another, with intervals of several millimeters between adjacent ones. To properly perform transfer of the workpieces W relative to the load ports 92, workpieces need to be transferred with high accuracy. In the conventional structure, however, transferring workpieces W with high accuracy is difficult when the vibration of the transfer chamber 91, the load ports 92 and the workpiece transfer apparatus 94 (the workpiece transfer system 9) is increased due to an increase in the workpiece transfer speed. Moreover, when the vibration of the workpiece transfer system 9 is increased, joint portions in the workpiece transfer system 9 are easily loosened or contact failure of a connector occurs easily. In this way, with the conventional structure, vibration caused by the operation of the workpiece transfer apparatus 94 can cause many problems.

### SUMMARY OF THE INVENTION

The present invention has been proposed under the circumstances described above. It is therefore an object of the present invention to provide a workpiece transfer system which includes a transfer chamber for installing a workpiece transfer apparatus and a load port provided adjacent to the transfer chamber and which is suitable for suppressing vibration during workpiece transferring operation. Another object of the present invention is to provide a frame structure suitable for constituting the transfer chamber of such a workpiece transfer system.

To solve the problems described above, the present invention takes the following technical measures.

According to a first aspect of the present invention, there is provided a workpiece transfer system comprising: a workpiece transfer apparatus; a transfer chamber in which the workpiece transfer apparatus is installed; and a load port adjacent to the transfer chamber. The transfer chamber includes a frame structure made of steel. The frame structure includes a first frame member and a second frame member, where the first frame member is set on a floor and on which the workpiece transfer apparatus is installed, and the second frame member is arranged in a standing posture with respect to the first frame member to support the load port.

In a preferred embodiment, the workpiece transfer system further comprises a rib for connecting the first frame member and the second frame member to each other.

In a preferred embodiment, the workpiece transfer system further comprises a connecting member for connecting the first frame member and the second frame member, where the first frame member has and end spaced apart from the second frame member, and the second frame member has an upper end. The connecting member connects the above-mentioned end of the first frame member and the upper end of the second frame member to each other.

In a preferred embodiment, the connecting member is provided with a vibration damping mechanism for suppressing vibration transmitted from the workpiece transfer apparatus.

In a preferred embodiment, the workpiece transfer system further comprises a joint member for fixing the first frame member to a concrete layer constituting the floor.

In a preferred embodiment, the transfer chamber further includes a cover attached to an edge of the frame structure and defining an internal space by cooperating with the frame structure, where the cover is smaller in weight than the frame structure. Preferably, the cover is attached to the frame structure via a resilient member.

According to a second aspect of the present invention, there is provided a frame structure for a work transfer chamber. The frame structure comprises a first frame member made of steel and on which a workpiece transfer apparatus is installed, and a second frame member made of steel and arranged in a standing posture with respect to the first frame member.

In the workpiece transfer system according to, the present invention, the frame structure in which a workpiece transfer apparatus is to be installed is made of steel. Thus, the frame structure has a relatively high specific gravity and high strength. Thus, even when vibration occurs in the workpiece transfer apparatus during the workpiece transferring operation, vibration of the frame structure is suppressed. Accordingly, vibration of the load port, which is supported by the second frame member of the frame structure, is also suppressed. Thus, according to the workpiece transfer system having the above-described structure, vibration of the transfer chamber (frame structure), the load port and the workpiece transfer apparatus is suppressed. As a result, workpieces are transferred with high accuracy even when transferred at a relatively high speed because of an increase in the workpiece size.

Other features and advantages of the present invention will become more apparent from detailed description given below with reference to the accompanying drawings.

### BRIEF DESCRIPTION OF THE DRAWINGS

FIG. 1 is a plan view showing an overall structure of a workpiece transfer system according to the present invention;

FIG. 2 is a side view of the workpiece transfer system;

FIG. 3 is a schematic sectional view taken along lines in FIG. 1;

FIG. 4 is an exploded perspective view of the transfer chamber;

FIG. 5 is a perspective view showing an installation structure of the frame structure relative to a floor; and

FIG. 6 is a plan view showing an example of a conventional workpiece transfer system.

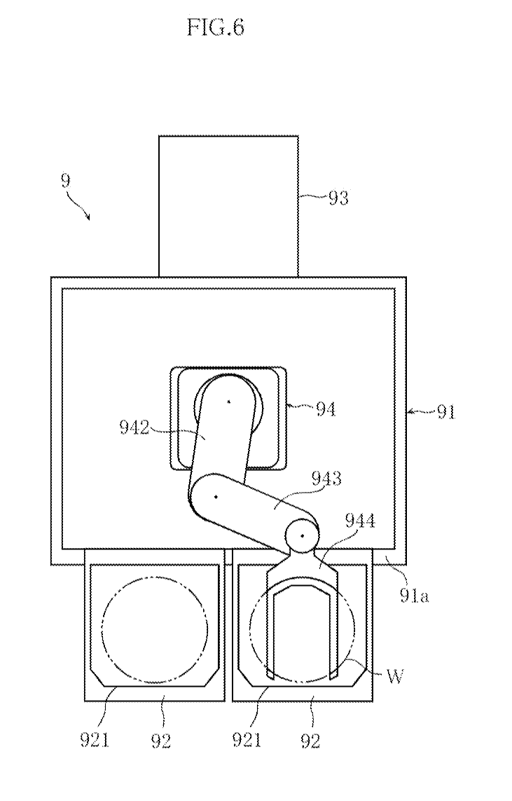

### DETAILED DESCRIPTION OF THE PREFERRED EMBODIMENTS

Preferred embodiments of the present invention will be described below with reference to the accompanying drawings;

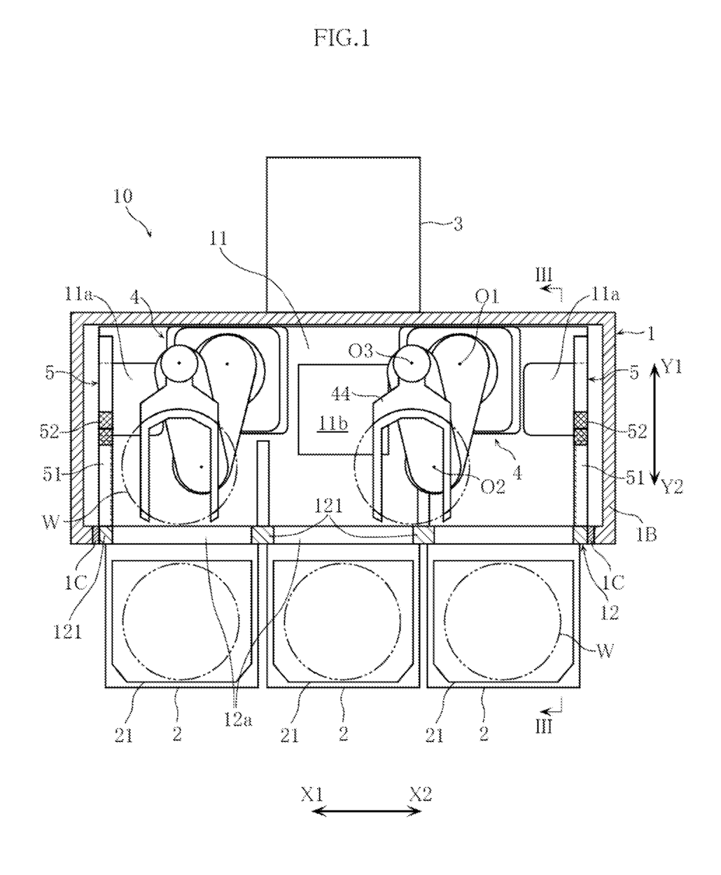

FIG. 1 shows an example of a workpiece transfer system according to the present invention. The workpiece transfer system 10 according to this embodiment is designed to transfer workpieces W in the form of a thin plate such as wafers, and includes a transfer chamber 1, three load ports 2, a workpiece treatment chamber 3 and two workpiece transfer apparatuses 4.

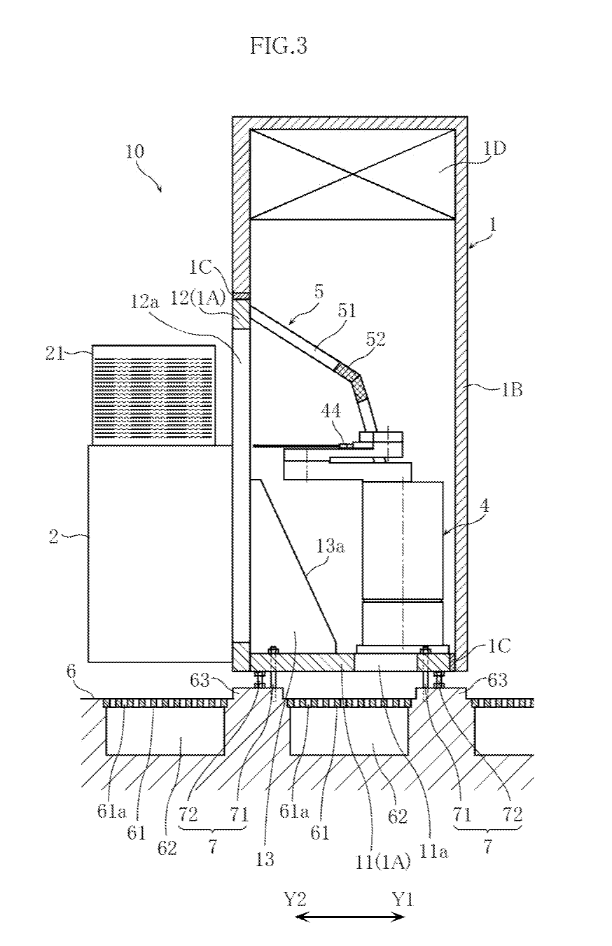

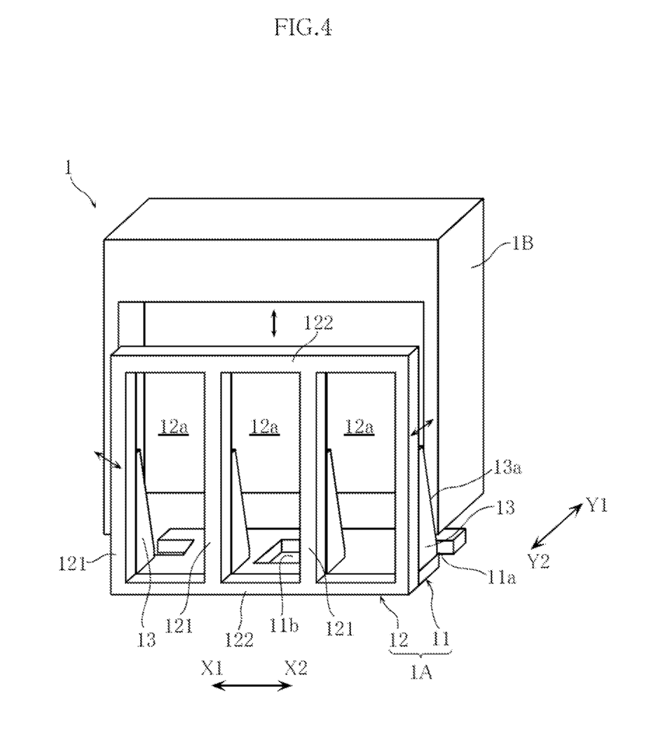

The transfer chamber 1 is generally in the form of a rectangular parallelepiped having an internal space, in which the workpiece transfer apparatuses 4 are installed. As shown in FIGS. 3 and 4, the transfer chamber 1 is made up of a frame structure 1A and a cover 1B. The frame structure 1A constitutes the base supporting structure of the transfer chamber 1 and includes a first frame member 11 to be installed on a floor and a second frame member 12 which is in a standing posture with respect to the first frame member 11. The first frame member 11 and the second frame member 12 are made of e.g. steel having a relatively high specific gravity. The first and the second frame members 11 and 12 can be made by the combination of shape steel and steel plates, for example.

The first frame member 11 constitutes the bottom of the transfer chamber 1 and is elongated in the direction X1-X2 in which the load ports 2 to be described later are aligned. The two workpiece transfer apparatuses 4 are fixedly set on the first frame member 11 with a predetermined space defined between them in the direction X1-X2. The first frame member 11 includes a cutout 11a at each end in the direction X1-X2, and an opening 11a at a position between the two workpiece transfer apparatuses 4. The first frame member 11 can be made of a single piece of steel, but may be made by connecting a plurality of pieces of steel by appropriate means such as bolting or welding.

The second frame member 12 constitutes a portion to support the load ports 2. The second frame member stands vertically at one of the ends spaced from each other in the direction Y1-Y2 which is perpendicular to the direction X1-X2 in plan view. The second frame member 12 includes three openings 12a at locations corresponding to the load ports 2. Specifically, the second frame member 12 includes four vertical frame portions 121 which extend vertically. The vertical frame portions 121 are arranged at the ends spaced from each other in the direction X1-X2 and between adjacent openings 12a. The second frame member 12 further includes two lateral frame portions 122 extending in the direction X1-X2 and arranged at an upper end and a lower end. The second frame member 12 may be made by connecting a plurality of pieces of steel by appropriate means such as bolting or welding.

The first frame member 11 and the second frame member 12 are connected to each other via a plurality of ribs 13. In this embodiment, four ribs 13 are provided at locations corresponding to the vertical frame portions 121 of the second frame member 12. Each of the ribs 13 is attached to the first frame member 11 at a region extending from one of the edges spaced from each other in the direction Y1-Y2 to an intermediate portion in the direction Y1-Y2, and attached also to the vertical frame portion 121 at a region extending from the lower end to an intermediate portion. As shown in FIG. 3, each rib 13 includes an inclined surface 13a that shifts to a lower position as proceeding away from the second frame member 12. The bonding between the first frame member 11, the second frame member 12 and the ribs 13 can be performed by appropriate means such as welding or bolting.

The first frame member 11 and the second frame member 12 are connected to each other via a connecting member 5. In this embodiment, two connecting members 5 are provided at the ends of the frame structure 1A which are spaced from each other in the direction X1-X2. Each of the connecting members 5 is made up of a frame element 51 made of a material having a relatively high rigidity such as steel, and a vibration damping mechanism 52 (indicated by cross-hatching in the figures) provided at an intermediate portion of the frame element 51. One end of the frame element 51 is attached to an end of the first frame member 11 which is spaced from the second frame member 12, whereas the other end of the frame element 51 is attached to the upper end of the second frame member 12.

The vibration damping mechanism 52 functions to suppress the vibration transmitted from the workpiece transfer apparatuses 4. Though not illustrated, the vibration damping mechanism 52 comprises e.g. a damper including a resilient member or a stabilizer including a link mechanism. The connecting member 5 may not be provided with the vibration damping mechanism 52. For instance, the entirety of the connecting member 5 may comprise a frame element having a relatively high rigidity.

The cover 1B is attached to the frame structure 1A to define the internal space of the transfer chamber 1 together with the frame structure 1A. The cover 1B is made of a material smaller in weight than the frame structure 1A. Though not illustrated, the cover 1B includes a support structure made of e.g. aluminum profile and a thin panel covering the support structure. As shown in FIGS. 1 and 3, the cover 1B is attached to the edges of the frame structure 1A via resilient members 1C made of e.g. rubber.

The load ports 2 are provided adjacent to the transfer chamber 1. A cassette 21 for holding workpieces is set to each of the load ports 2. The load ports 2 are attached to the vertical frame portions 121 (the second frame member 12) of the frame structure 1A by e.g. bolting. The cassette 21 includes a holder (not shown) capable of holding a plurality of workpieces W in a stacked manner. Each of the load ports 2 is provided with a shutter (not shown) at a side surface on the transfer chamber 1 side, which opens to allow communication or closes to prevent communication between the cassette 21 and the transfer chamber 1 (the opening 12a of the second frame member 12).

The workpiece treatment chamber 3 is provided for performing treatment such as heating, working or testing with respect to the workpieces W. The workpiece treatment chamber 3 is arranged on the side of the transfer chamber 1 opposite from the load ports 2 and at the center of the workpiece transfer system 10 in the direction X1-X2. A shutter (not shown) that can be opened or closed is provided between the workpiece treatment chamber 3 and the transfer chamber 1 (the cover 1B).

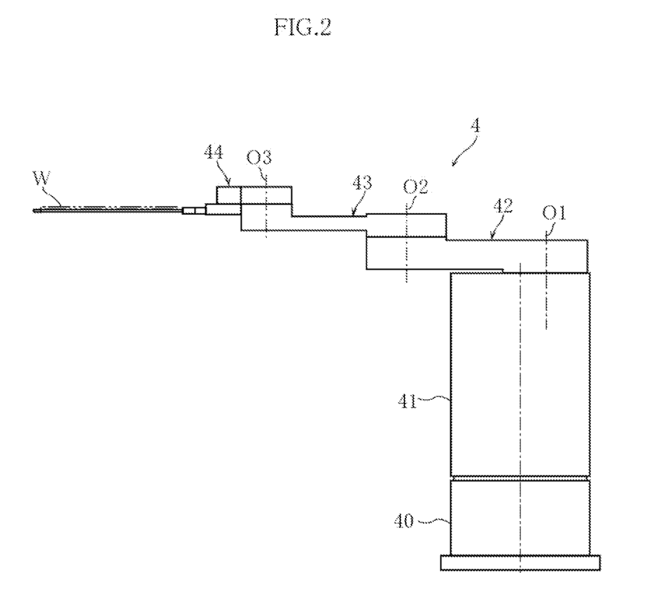

The workpiece transfer apparatuses 4 transfer the workpieces W between the load ports 2 and the workpiece treatment chamber 3 and are arranged in the transfer chamber 1. As shown in FIGS. 2 and 3, each of the workpiece transfer apparatuses 4 includes a stationary base 40 fixed to the first frame member 11 of the frame structure 1A of the transfer chamber 1, an elevation base 41, elongated lower arm 42 and upper arm 43, and a hand 44.

The elevation base 41 is supported on the stationary base 40 and vertically movable by the operation of an elevation driving mechanism, not shown. The base end of the lower arm 42 is supported on the elevation base 41 rotatably around the vertical axis O1. Thus, the lower arm 42 is rotatable around the vertical axis O1 by the operation of a lower arm driving mechanism, not shown. The base end of the upper arm 43 is supported on the distal end of the lower arm 42 rotatably around the vertical axis O2. Thus, the upper arm 43 is rotatable around the vertical axis O2 by the operation of an upper arm driving mechanism, not shown. The distal end of the hand 44 is bifurcated. The base end of the hand 44 is supported on the distal end of the upper arm 43 rotatably around the vertical axis O3. Thus, the hand 44 is rotatable around the vertical axis O3 by the operation of a hand driving mechanism, not shown. The workpiece transfer apparatus 4 includes a workpiece holding mechanism, not shown, for sucking and holding workpieces W by e.g. vacuum suction. A connector (not shown) for performing power supply and control signal transmission relative to the above-described driving mechanisms and the workpiece holding mechanism is provided at a lower portion of a side surface of the stationary base 40.

Detailed explanation and illustration of the support structure of the elevation base 41, arms 42, 43 and hand 44, the elevation driving mechanism, each of the arm driving mechanisms, the hand driving mechanism and the workpiece holding mechanism are omitted in this specification. These structures can be realized in a similar manner to the structures disclosed in JP-A-2003-188231, for example.

Each of the two workpiece transfer apparatuses 4 is controlled by a non-illustrated controller. In the workpiece transfer apparatus 4, the operations of the lower arm driving mechanism, the upper arm driving mechanism and the hand driving mechanism can be independently controlled so that the lower arm 42, the upper arm 43 and the hand 44 can be rotated around the vertical axes O1, O2 and O3, respectively. Thus, by appropriately controlling the rotation of each of the lower arm 42, the upper arm 43 and the hand 44, the hand 44 is moved to a desired position within the range in which these members are rotatable about the vertical axes O1, O2 and O3. By appropriately controlling the elevation driving mechanism, the hand is moved to a desired height within a predetermined range. By operating each driving mechanism of the workpiece transfer apparatus 4, the hand 44 is allowed to enter the cassette 21 on the load port 21 or the workpiece treatment chamber 3 to transfer the workpieces W into or out of the cassette 21 or the workpiece treatment chamber 3. Specifically, the transfer of the workpieces W in the cassette 21 or the workpiece treatment chamber 3 is performed by appropriately moving the elevation base 41 vertically to move up or down the hand 44.

The clearances between the stationary base 40 and the elevation base 41, between the elevation base 41 and the lower arm 42, between the lower arm 42 and the upper arm 43, and between the upper arm 43 and the hand 44 may be closed with a sealing member, not shown. With this arrangement, the internal space of the workpiece transfer apparatus 4 is hermetically sealed relative to the outside, so that undesirable particles such as dust in the workpiece transfer apparatus 4 are prevented from being scattered in the transfer chamber 1.

As shown in FIG. 1, the two workpiece transfer apparatuses 4 are spaced from each other by a predetermined distance so that they do not interfere with each other during the workpiece transferring operation. For instance, the two workpiece transfer apparatuses 4 are arranged at an equal distance from the center of the transfer chamber 1 in the direction X1-X2.

The workpiece transfer system 10 of this embodiment is used in a clean environment. As shown in FIG. 3, a fan filter unit 1D for supplying clean air into the transfer chamber 1 is provided in an upper portion of the transfer chamber 1. The floor 6 of the building of e.g. semiconductor device manufacturing facilities in which the workpiece transfer system 10 is installed is provided with a ventilation portion 61 formed with a number of through-holes 61a. The ventilation portion 61 is provided below the transfer chamber 1. A duct 62 is provided below the ventilation portion 61. When clean air is supplied from the fan filter unit 1D, down flow is generated in the transfer chamber 1. Thus, the air in the transfer chamber 1 is discharged to the outside through the cutouts 11a and the opening 11b of the first frame member 11, the ventilation portion 61 and the duct 62. With this arrangement, the internal space of the transfer chamber 1 is maintained in a clean environment.

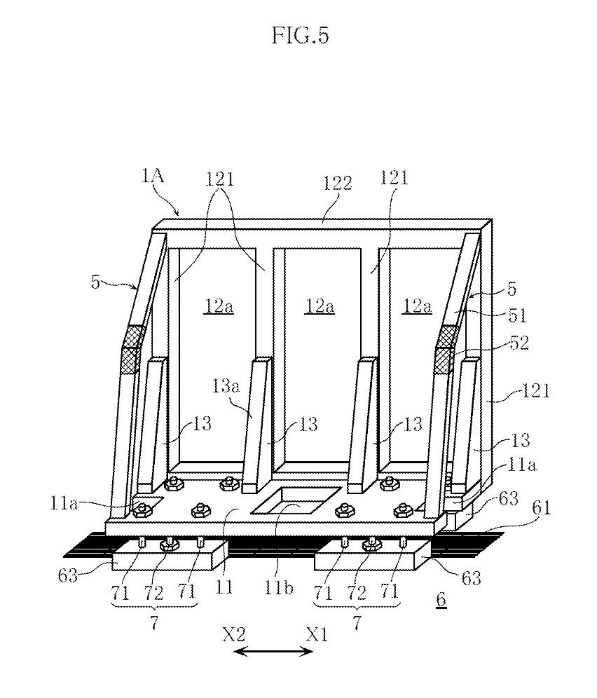

The transfer chamber 1 having the above-described structure is fixed to the building with a joint member 7. Specifically, the floor 6 of the building is made of a concrete layer, and as shown in FIGS. 3 and 5, the concrete layer is formed with support portions 63 for supporting the transfer chamber 1. For instance, the joint member 7 comprises tension bolts 71 and a compression bolt 72. The support portions 63 are raised to be higher than the ventilation portion 61. The first frame member 11 of the frame structure 1A is fixed to the support portions 63 via the tension bolts 71 and the compression bolt 72. With this arrangement, the first frame member 11 is connected to the support portions 63 with a clearance defined between them to allow height adjustment. Accordingly, the height of the transfer chamber 1 is adjustable.

In the workpiece transfer system 10 of this embodiment, the frame structure 1A (the first frame member 11) on which the workpiece transfer apparatus 1 is installed is made of steel. Thus, the frame structure 1A has a relatively high specific gravity and high strength. Thus, even when vibration occurs in the workpiece transfer apparatus 4 during the workpiece transferring operation, vibration of the frame structure 1A is suppressed. Accordingly, vibration of the load ports 2, which are supported by the second frame member 12 of the frame structure 1A, is also suppressed. Thus, according to the workpiece transfer system 10 having the above-described structure, vibration of the transfer chamber 1 (frame structure 1A), the load ports 2 and the workpiece transfer apparatuses 4 is suppressed. As a result, workpieces W are transferred with high accuracy even when transferred at a relatively high speed because of an increase in the workpiece size.

As noted above, the frame structure 1A constituting the transfer chamber 1 comprises the first frame member 11 on which the workpiece transfer apparatus 4 is installed and the second frame member 12 that supports the load ports 2. Steel, which is the material forming the frame structure 1A, is relatively expensive. With the above-described structure, the proportion of the frame structure 1A is suppressed to the minimum, which prevents an increase in the manufacturing cost of the transfer chamber 1.

The first frame member 11 and the second frame member 12 of the frame structure 1A are connected to each other via ribs 13. This arrangement enhances the strength of the frame structure 1A, which is favorable for suppressing vibration of the frame structure 1A, the load ports 2 and the workpiece transfer apparatuses 4.

In the frame structure 1A, an end of the first frame member 11 and an end of the second frame member 12 are connected to each other via a connecting member 5. This connection of the first frame member 11 and the second frame member 12 by the connecting member 5 enhances the strength of the frame structure 1A. Since the connecting member 5 is provided with a vibration damping mechanism 52, the frame structure 1A has excellent vibration absorption ability. In this way, the provision of the connecting member 5 contributes to suppression of vibration of the frame structure 1A.

The frame structure 1A is fixed to the concrete layer (support portions 63) of the floor 6 of a building by the joint member 7 which may include e.g. a bolt. The workpiece transfer system 10 of this embodiment is used in a clean environment, and the ventilation portion 61 is provided directly below the transfer chamber 1. The frame structure 1A is strongly fixed to the concrete layer with a clearance defined between itself and the ventilation portion 61. With the above-described structure, the building in which the workpiece transfer system 10 is installed serves as a weight for vibration absorption, while the internal space of the transfer chamber is kept in a clean environment. This contributes to vibration suppression of the frame structure 1A.

The cover 1B constituting the transfer chamber 1 is made of a light material (e.g. aluminum) and attached to the edges of the frame structure 1A via the resilient members 1C. With this structure, even when vibration occurs due to the treatment performed in the workpiece treatment chamber 3 provided adjacent to the transfer chamber 1 (cover 1B), the vibration is absorbed by the resilient members 1C. Thus, the effect of vibration from the workpiece treatment chamber 3 is suppressed, while reducing the weight and manufacturing cost of the transfer chamber 1 (cover 1B).

While the preferred embodiment of the present invention has been described above, the technical scope of the present invention is not limited to the above-described embodiment. The specific structure of each part of the workpiece transfer system and the frame structure for a transfer chamber can be modified in many ways without departing from the spirit of the invention.

For instance, although two workpiece transfer apparatuses 4 are installed in the transfer chamber 1 in the above-described embodiment, the number of the workpiece transfer apparatuses 4 installed in the transfer chamber 1 is not limited to two.

Although the workpiece transfer apparatuses 4 in the above-described embodiment are of a single hand type provided with only one hand 44, the present invention is also applicable to e.g. a workpiece transfer apparatus of a double hand type provided with two hands.

In the above-described embodiment, the first frame member 11 of the frame structure 1A is fixed to the concrete layer of the floor 6 by using a joint member 7 (tension belt 71 and compression belt 72), with a clearance defined between the first frame member 11 and the floor 6. However, the structure related to fixing of the first frame member 11 to the floor side is not limited to this. For instance, the joint member 7 may have vibration absorption function which may be provided by a damper. The first frame member may be fixed to the floor by using anchor bolts without leaving a clearance between itself and the floor. When the workpiece transfer system of the present invention is not used in a clean environment, the entirety of the bottom surface of the first frame member may be held in close contact with the floor.

1. A workpiece transfer system comprising:
a workpiece transfer apparatus;
a transfer chamber in which the workpiece transfer apparatus is installed; and
a load port adjacent to the transfer chamber:
wherein the transfer chamber includes a frame structure made of steel, and
the frame structure includes a first frame member and a second frame member, the first frame member being set on a floor and on which the workpiece transfer apparatus is installed, the second frame member being arranged in a standing posture with respect to the first frame member and supporting the load port.

2. The workpiece transfer system according to claim 1, further comprising a rib for connecting the first frame member and the second frame member to each other.

3. The workpiece transfer system according to claim 1, further comprising a connecting member for connecting the first frame member and the second frame member, wherein the first frame member has an end spaced apart from the second frame member, and the second frame member has an upper end, the connecting member connecting said end of the first frame member and the upper end of the second frame member to each other.

4. The workpiece transfer system according to claim 3, wherein the connecting member is provided with a vibration damping mechanism for suppressing vibration transmitted from the workpiece transfer apparatus.

5. The workpiece transfer system according to claim 1, further comprising a joint member for fixing the first frame member to a concrete layer constituting the floor.

6. The workpiece transfer system according to claim 1, further comprising a cover attached to an edge of the frame structure and defining an internal space by cooperating with the frame structure, wherein the cover is smaller in weight than the frame structure.

7. The workpiece transfer system according to claim 6, further comprising a resilient member for attaching the cover to the frame structure.

8. A frame structure for a work transfer chamber comprising:
a first frame member made of steel and on which a workpiece transfer apparatus is installed; and
a second frame member made of steel and arranged in a standing posture with respect to the first frame member.
